(19) United States
(12) Patent Application Publication
(10) Pub. No.: US 2016/0014811 A1
(43) Pub. Date: Jan. 14, 2016

(54) Methods for Providing Concurrent Communications among Multiple Wireless Communications Devices

(71) Applicant: MEDIATEK INC., Hsinchu (TW)

(72) Inventors: Yuh-Ren Jauh, Taoyuan City (TW); Chao-Chun Wang, Taipei City (TW)

(21) Appl. No.: 14/794,680

(22) Filed: Jul. 8, 2015

Related U.S. Application Data
(60) Provisional application No. 62/021,776, filed on Jul. 8, 2014.

(51) Int. Cl. H04W 74/00; H04B 7/04; H04L 5/00

(52) U.S. Cl. CPC H04W 74/006; H04L 5/0007; H04B 7/0452

(57) ABSTRACT

Methods are provided for concurrent communications among multiple wireless communications devices. In one novel aspect, the wireless station transmits a wideband signal to a plurality of wireless communications devices using downlink MIMO and/or OFDMA. The wireless station receives a plurality of responding frames from the plurality of wireless communications devices concurrently using OFDMA. In one embodiment, the wireless station transmits a MU indication bit and MU bandwidth assignment information in the downlink MIMO and/or OFDMA frames. In another novel aspect, the uplink responding frames from multiple wireless communications devices are sent on a corresponding narrow concurrently over more than one transmission instance. AP polling or SIFS only is used between two transmission instances. When the concurrent responding frames occupies less than a bandwidth of an available uplink OFDMA bandwidth, the unoccupied bandwidth is either left empty or occupied by one or more duplicated responding frames.

### CROSS REFERENCE TO RELATED APPLICATIONS

This application claims priority under 35 U.S.C. §119 from U.S. Provisional Application No. 62/021,776, entitled, “MU-ACK FOR DOWNLINK MU-MIMO” filed on Jul. 8, 2014; the subject matter of which is incorporated herein by reference.

### TECHNICAL FIELD

The disclosed embodiments relate generally to wireless communication, and, more particularly, to methods for providing concurrent communications among multiple wireless communications devices.

### BACKGROUND

Multi-user multiple-input multiple-output (MU-MIMO) transmission is becoming a new system technique to enable high system capacity. As compared to single-user MIMO (SU-MIMO), MU-MIMO has several key advantages. First, MU-MIMO allows for a direct gain in multiple access system capacity proportional to the number of access point antennas. Second, MU-MIMO allows the higher degree spatial multiplexing gain to be obtained without the need for higher number of antennas at the mobile stations by keeping the intelligence and cost at the access point. Third, MU-MIMO appears immune to most propagation limitations plaguing SU-MIMO communications because multiuser diversity can be extracted even in a simple line of sight (LOS) propagation environment. As a result, the LOS propagation, which causes degradation in single user spatial multiplexing schemes, is no longer a problem in the multiuser setting. The amount of data transmitted over the internet has been growing exponentially. Further, with the rapid development of the technology, wireless connections will not only connect people via voice and data communications but also will connect smart devices, also called Internet of Things (IoT). The number of devices connected through wireless communication demands higher efficiency of the wireless network. Consequently, MU-MIMO becomes more widely adopted.

In the wireless system, the downlink MU-MIMO will need multiple stations to feedback acknowledgement in the uplink. One way to send the uplink feedback for MU-MIMO is to send the feedback sequentially. For example, in IEEE 802.11ac MU-MIMO, the first user will send the feedback the response immediately. The following users will send the feedback after polling by the access point (AP). The sequential feedback using AP polling in the uplink direction limits the system efficiency.

Improvement and enhancement are required for uplink feedback responses for MU-MIMO.

### SUMMARY

Methods are provided for concurrent communications among multiple wireless communications devices. In one novel aspect, the wireless station communicates with a plurality of wireless communications devices by using multiple users multiple input and multiple output (MU-MIMO) and Orthogonal Frequency Demodulation Multiple Access (OFDMA) transmission. The wireless station transmits a wideband signal to a plurality of wireless communications devices using downlink MIMO and/or OFDMA. The wireless station receives a plurality of responding frames from the plurality of wireless communications devices concurrently each using a corresponding uplink narrow band. In one embodiment, the pluralities of frames are sent concurrently using OFDMA. In another embodiment, the wireless station transmits a MU indication bit and MU bandwidth assignment information in the downlink MIMO and/or OFDMA frames. In yet another embodiment, the MU indication bit is included in the PHY SIG field. The MU bandwidth assignment information is included in the PHY SIG field.

In another novel aspect, the uplink responding frames from multiple wireless communications devices are sent on a corresponding narrow concurrently over more than one transmission instance. In one embodiment, AP polling is used between two transmission instances. In another embodiment, only SIFS is used in between the two transmission instances. In one embodiment, when the concurrent responding frames occupies less than a bandwidth of an available uplink OFDMA bandwidth, the unoccupied bandwidth is either left empty or occupied by one or more duplicated responding frames of one wireless communications devices. In yet another embodiment, the mixed use of the sequential uplink responding frames and the concurrent uplink OFDMA responding frames are used.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary wireless network 100 with downlink MU-MIMO and/or OFDMA scheme and concurrent uplink feedback in accordance with embodiments of the current invention.

FIG. 2 illustrates an exemplary diagram in a wireless system with downlink MU-MIMO and/or OFDMA scheme and concurrent responding feedbacks in accordance with embodiments of the current invention.

FIG. 3 shows an exemplary configuration for multiple wireless communications devices to send the corresponding responding frames concurrently over more than one transmission instances in accordance with embodiments of the current invention.

FIG. 4 shows and exemplary configuration for multiple wireless communications devices to send the corresponding responding frames concurrently over more than one transmission instances using AP polls in accordance with embodiments of the current invention.

FIG. 5 shows an exemplary diagram for multiple wireless communications devices to send the corresponding responding frames concurrently over more than one transmission instances and at least one transmission instance has less than the maximum allowed wireless communications devices in accordance with embodiments of the current invention.

FIG. 6A shows an exemplary diagram for uplink responding frames using MU OFDMA by leaving the unoccupied bandwidth empty in accordance with embodiments of the current invention.

FIG. 6B shows an exemplary diagram for uplink responding frames using MU OFDMA by occupying the bandwidth with duplicated responding frames in accordance with embodiments of the current invention.

FIG. 7 shows an exemplary diagram of a mixed use the sequential responding frames and the concurrent OFDMA uplink responding frames in accordance with embodiments of the current invention.

FIG. 8 shows an exemplary flow chart of a wireless station performs downlink MIMO/OFDMA with uplink MU responding frames using OFDMA in accordance with embodiments of the current invention.

FIG. 9 shows an exemplary flow chart of a wireless communication device performs downlink MIMO/OFDMA with uplink MU responding frames using OFDMA in accordance with embodiments of the current invention.

### DETAILED DESCRIPTION

Reference will now be made in detail to some embodiments of the invention, examples of which are illustrated in the accompanying drawings.

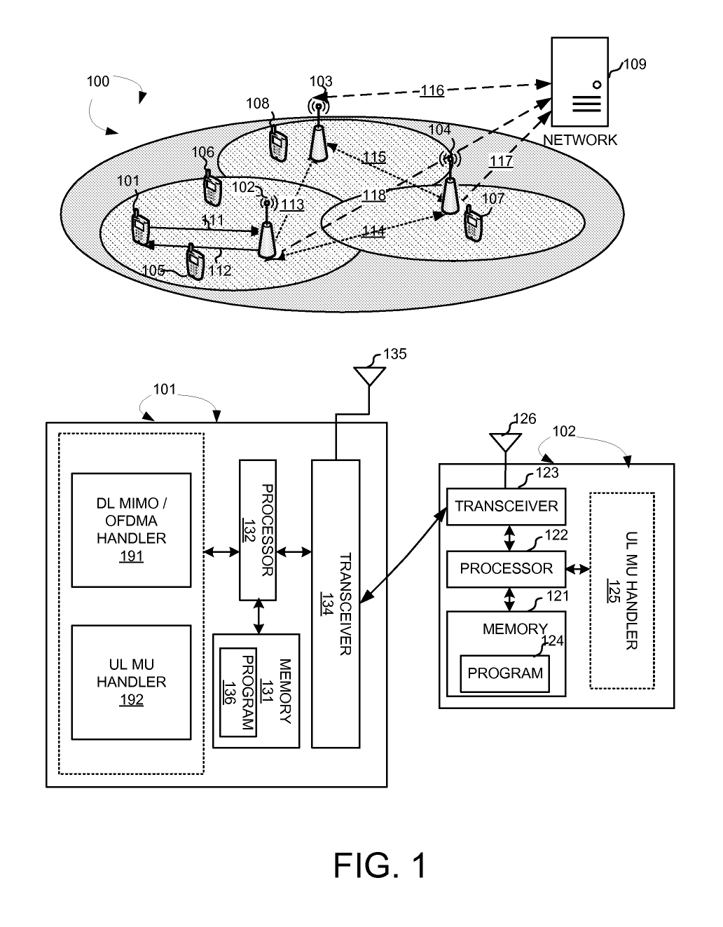

FIG. 1 illustrates an exemplary wireless network 100 with downlink MU-MIMO and concurrent uplink feedback in accordance with embodiments of the current invention. Wireless communication system 100 includes one or more wireless networks, each of the wireless communication network has a fixed base infrastructure unit, such as wireless communications stations 102 103, and 104, forming wireless networks distributed over a geographical region. The base unit may also be referred to as an access point, an access terminal, a base station, a Node-B, an eNode-B, or by other terminology used in the art. Each of the receiving wireless communications stations 102, 103, and 104 serves a geographic area. Backhaul connections 113, 114 and 115 connect the non-co-located wireless communications stations, such as 102, 103, and 104. These backhaul connections can be either ideal or non-ideal

A wireless communications device 101 in wireless network 100 is served by base station 102 via uplink 111 and downlink 112. Other wireless communications devices 105, 106, 107, and 108 are served by different base stations. Wireless communications devices 105 and 106 are served by base station 102. Wireless communications device 107 is served by base station 104. Wireless communications device 108 is served by base station 103.

In one embodiment, wireless communication network 100 is an OFDMA/MIMO system comprising base stations/access points (APs) 102, 103 and 104, and a plurality of mobile stations, such as wireless stations 101, 105, 106, 107 and 108. In the applications, each base station serves multiple wireless communications devices that periodically transmit packets. In some scenarios, huge number of wireless stations contenting for the wireless channel results in collisions, long transmission range leads to high interface spaces and short packets increase overhead caused by headers. In one novel aspect, downlink transmissions to multiple wireless stations using MIMO and/or OFDMA are aggregated. When there is a downlink packet to be sent from a base station to a mobile station, data frames from different mobile stations meeting certain criteria are aggregated using OFDMA and transmitted together. In another novel aspect, multi-user OFDMA is used for uplink transmission. A network entity, such as a wireless controller 109 is connected with base stations such as base stations 102, 103, and 104, via links of 116, 117, and 118.

FIG. 1 further shows simplified block diagrams of wireless stations 101 and base station 102 in accordance with the current invention.

Wireless communication station 102 has an antenna 126, which transmits and receives radio signals. A RF transceiver module 123, coupled with the antenna, receives RF signals from antenna 126, converts them to baseband signals and sends them to processor 122. RF transceiver 123 also converts received baseband signals from processor 122, converts them to RF signals, and sends out to antenna 126. Processor 122 processes the received baseband signals and invokes different functional modules to perform features in base station 102. Memory 121 stores program instructions and data 124 to control the operations of base station 102. Base station 102 also includes a set of control modules, such as UL MU handler 125 that carry out functional tasks to communicate with wireless communications devices.

Wireless communications device 101 has an antenna 135, which transmits and receives radio signals. A RF transceiver module 134, coupled with the antenna, receives RF signals from antenna 135, converts them to baseband signals and sends them to processor 132. RF transceiver 134 also converts received baseband signals from processor 132, converts them to RF signals, and sends out to antenna 135. Processor 132 processes the received baseband signals and invokes different functional modules to perform features in mobile station 101. Memory 131 stores program instructions and data 136 to control the operations of mobile station 101.

Wireless communications device 101 also includes a set of control modules that carry out functional tasks. A downlink MIMO/OFDMA handler 191 handles downlink data and control frames using MU-MIMO and/or OFDMA scheme. A UL MU handler 192 handles uplink responding frames using OFDMA.

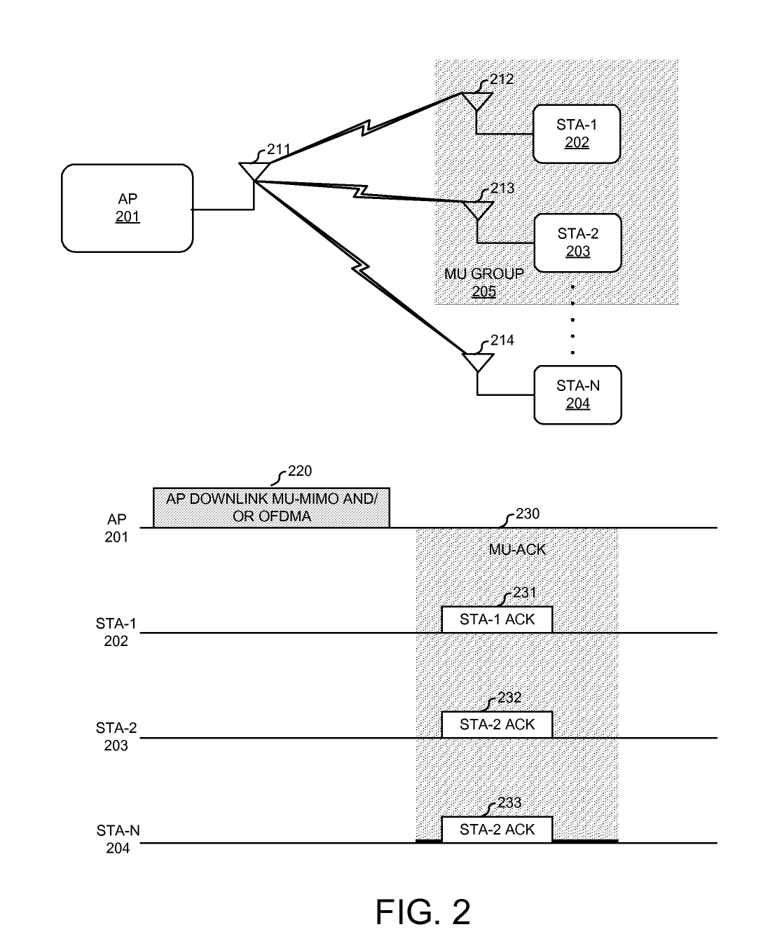

FIG. 2 illustrates an exemplary diagram in a wireless system with downlink MU-MIMO and/or OFMDA scheme and concurrent responding feedbacks in accordance with embodiments of the current invention. An AP 201, with antenna 211 is configured to support downlink MU-MIMO and/or OFDMA and uplink OFDMA. Exemplary multiple mobile stations STA-1 202, STA-2 203 and STA-N 204 connect to AP 201 via antennas 212, 213 and 214, respectively. In one embodiment, antennas 211 to 214, each is an antenna array in supporting of MIMO.

In one novel aspect, AP 201 transmits downlink information with wideband comprising of a plurality of narrow band channels. AP 201 transmits information to a plurality of wireless communications devices using MIMO and/or OFDMA. In one embodiment, AP 201 receives uplink responding frames from the plurality of wireless communications stations concurrently using OFDMA. In one embodiment, AP 201 exchanges capacity information with the plurality of wireless communications devices, such as STA-1 202, STA-2 203, and STA-N 204. Based on the capacity information, uplink responding message can be sent concurrently using OFDMA or can be sent sequentially using AP polling.

FIG. 2 further illustrates the base station initiates MU operation in accordance to embodiments of the current invention. Multiple STAs STA-1 202, STA-2 203, and STA-N 204 are connected with AP 201. In one embodiment, the wireless communications devices receive downlink transmission from wireless stations, such as AP 201, using MIMO or OFDMA scheme. In one embodiment, the downlink frames can be data transmission or control frames. In one example, STA-1 202 and STA-2 203 are configured to be in one MU group 205. STA-N 204 is in a different MU group based on the capacity information.

In one embodiment, the downlink frames can be data frames. At step 220, AP 201 transmits downlink data to STA-1 202, STA-2 203, and STA-N 204, using MU-MIMO and/or OFDMA. In one embodiment, both MU-MIMO and OFDMA are used for the downlink transmission, with a first subset of wireless communications devices receiving MU-MIMO frames, while a second subset of wireless communications devices receiving OFMDA frames. In another embodiment, the AP transmits downlink data frames. In yet another embodiment, control frames are transmitted using MU-MIMO or OFDMA. In one embodiment, the control frames is the clear-to-send (CTS) message. Upon receiving the downlink frames, one or more wireless communications devices send responding messages using OFDMA. Each wireless communications device replies a responding message in different frequency band concurrently. As shown in FIG. 2, STA-1 202, STA-2 203 and STA-N 204 respond with an ACK messages in different frequency bands concurrently at steps 231, 232, and 233, respectively.

In one novel aspect, an indication is included to indicate the configuration for concurrent responding using uplink OFDMA. In one embodiment, an indication bit is included in the physical layer signal field (PHY SIG). The bandwidth assignment for the uplink responding frames can be included in PHY SIG field or be predefined or preconfigured. The preconfigured bandwidth is at least based on the number of wireless communications devices in the MU group. Upon detecting this indicator, the wireless communications devices start uses OFDMA for uplink responding messages. There are different configurations based on the number of wireless communications devices and the bandwidth of the uplink OFDMA channel.

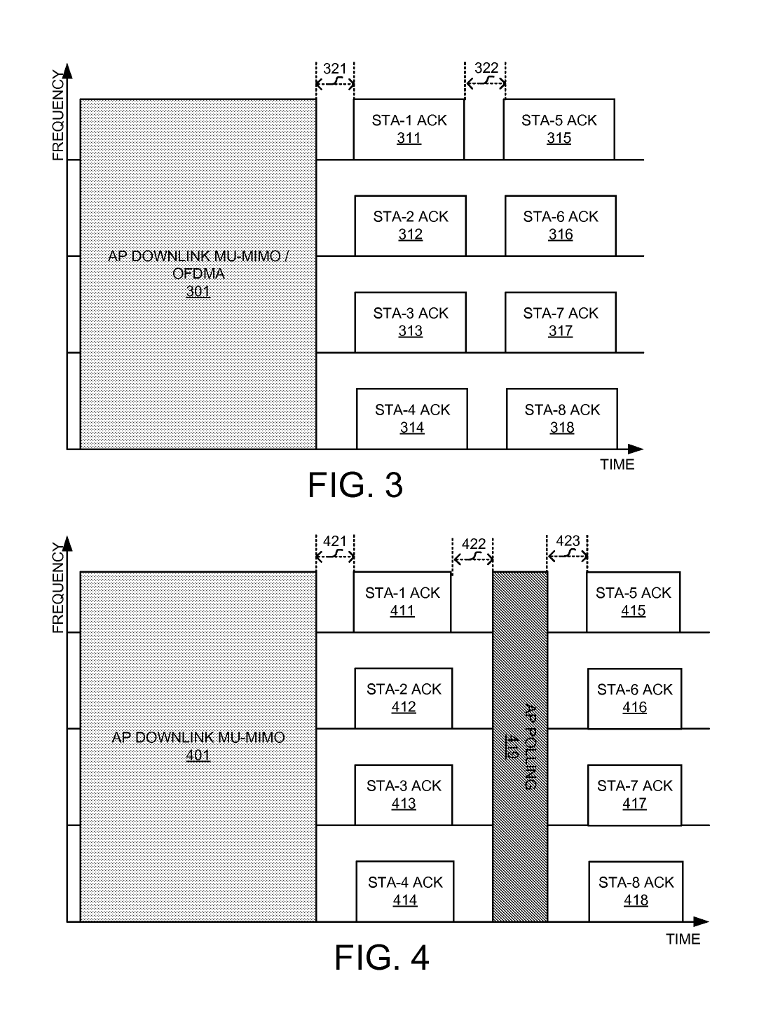

FIG. 3 shows an exemplary diagram for multiple wireless communications devices to send the corresponding responding frames concurrently over more than one transmission instances in accordance with embodiments of the current invention. At step 301, the wireless communication station sends downlink wideband signal to multiple wireless communications devices, STA-1 to STA-8. In one example, the bandwidth needed for the responding message for each communications device is 20M. The total uplink OFDMA bandwidth is 80M. Therefore, there are total of four wireless communication devices can send the uplink responding frames concurrently. STA-1, STA-2, STA-3, and STA-4 are configured to be in the first subset to send their responding frames concurrently using uplink OFDMA at steps 311, 312, 313, and 314, respectively. STA-5, STA-6, STA-7, and STA-8 are configured to be in the second set to send their responding frames concurrently using uplink OFDMA at steps 315, 316, 317, and 318, respectively. Upon receiving the downlink frames, the first set of wireless communications devices back off for a short inter-frame space (SIFS) 321. The first set of communications devices send their responding frames in different frequency band concurrently using OFDMA. The second set of wireless communications devices, after backing off for SIFS 322, send their responding frames in different frequency band concurrently using OFDMA.

If the total bandwidth required to send responding frames from multiple wireless communication devices is greater than the available uplink OFDMA bandwidth, multiple OFDMA packets with SIFS spacing are used. In another embodiment, if the total bandwidth required sending responding frames from multiple wireless communication devices is greater than the available uplink OFDMA bandwidth, AP polls the second set of wireless communications devices for the second transmission instance.

FIG. 4 shows an exemplary diagram for multiple wireless communications devices to send the corresponding responding frames concurrently over more than one transmission instances using AP polls in accordance with embodiments of the current invention. At step 401, the wireless communication station sends downlink wideband signal to multiple wireless communications devices, STA-1 to STA-8. As the uplink OFDMA bandwidth is smaller than the total bandwidth required for the responding frames, multiple transmission instances are used. STA-1, STA-2, STA-3, and STA-4 are configured to be in the first subset to send their responding frames concurrently using uplink OFDMA at steps 411, 412, 413, and 414, respectively. STA-5, STA-6, STA-7, and STA-8 are configured to be in the second set to send their responding frames concurrently using uplink OFDMA at steps 415, 416, 417, and 418, respectively. Upon receiving the downlink frames, the first set of wireless communications devices back off for a short inter-frame space (SIFS) 421. The first set of communications devices send their responding frames in different frequency band concurrently using OFDMA. AP polling is used for the second set of the wireless communications devices. After SIFS 422, AP polling for the second set of wireless communications devices at step 419. The second set of wireless communications devices, after backing off for SIFS 423, send their responding frames in different frequency band concurrently using OFDMA.

In another novel aspect, the wireless communications devices can be assigned to different MU group for uplink OFDMA transmission even when the uplink OFMDA has enough bandwidth for the responding frames.

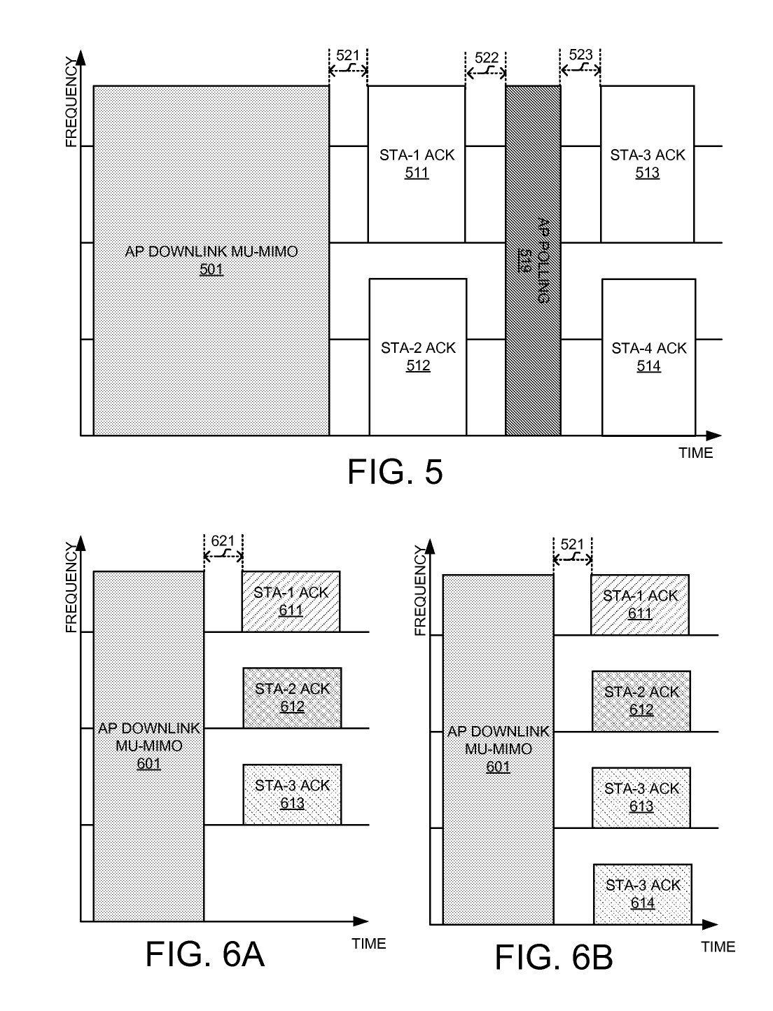

FIG. 5 shows an exemplary diagram for multiple wireless communications devices to send the corresponding responding frames concurrently over more than one transmission instances and at least one transmission instance has less than the maximum allowed wireless communications devices in accordance with embodiments of the current invention. At step 501, the wireless communication station sends downlink wideband signal to multiple wireless communications devices, STA-1 to STA-4. Although the responding frames from STA-1 to STA-4 can fit in the bandwidth of the uplink OFDMA transmission, different configuration can be adopted. As shown, STA-1 and STA-2 are configured to be in the first subset to send their responding frames concurrently using uplink OFDMA at steps 511 and 512, respectively. STA-3 and STA-4 are configured to be in the second set to send their responding frames concurrently using uplink OFDMA at steps 513 and 514, respectively. Upon receiving the downlink frames, the first set of wireless communications devices back off for a short inter-frame space (SIFS) 521. The first set of communications devices send their responding frames in different frequency band concurrently using OFDMA. AP polling is used for the second set of the wireless communications devices. After SIFS 522, AP polling for the second set of wireless communications devices at step 519. The second set of wireless communications devices, after backing off for SIFS 523, send their responding frames in different frequency band concurrently using OFDMA. In another embodiment, the second set of wireless communications devices can send their responding frames using OFDMA after SIFS without AP polls.

In other embodiments, the multiple responding frames from corresponding wireless devices may not occupy the entire uplink bandwidth. Different approaches are used for the unoccupied bandwidth. In one embodiment, the unoccupied bandwidth is left empty. In another embodiment, duplicated responding frames are used to occupy the unused bandwidth.

FIG. 6A shows an exemplary diagram for uplink responding frames using MU OFDMA by leaving the unoccupied bandwidth empty in accordance with embodiments of the current invention. At step 601, the wireless communication station sends downlink wideband signal to multiple wireless communications devices, STA-1, STA-2, STA-3. Upon receiving the downlink frames, the wireless communications devices back off for a short inter-frame space (SIFS) 621. STA-1, STA-2, and STA-3 send corresponding responding frames in different frequency bands concurrently at steps 611, 612, and 613, respectively. The unoccupied bandwidth is left empty, leaving the bandwidth no energy.

FIG. 6B shows an exemplary diagram for uplink responding frames using MU OFDMA by occupying the bandwidth with duplicated responding frames in accordance with embodiments of the current invention. At step 601, the wireless communication station sends downlink wideband signal to multiple wireless communications devices, STA-1, STA-2, STA-3. Upon receiving the downlink frames, the wireless communications devices back off for a short inter-frame space (SIFS) 621. STA-1, STA-2, and STA-3 send corresponding responding frames in different frequency bands concurrently at steps 611, 612, and 613, respectively. The unoccupied bandwidth is filled with a duplicated responding frame from STA-3. In other embodiments, when there are multiple unoccupied frequency bands, one or more duplicated responding frames can be used to either entirely occupy the whole bandwidth or occupy a portion of the unoccupied bandwidth. The duplicated responding frame can be randomly picked. In other embodiment, the duplicated responding frames can be predefined or preconfigured.

Due to the rapid development of the technology, some wireless communications devices may not support the OFDMA. In other scenarios, sequential responding frames are preferred. In either of the cases, the mixed use of the sequential responding frame and the concurrent OFDMA responding frames is allowed.

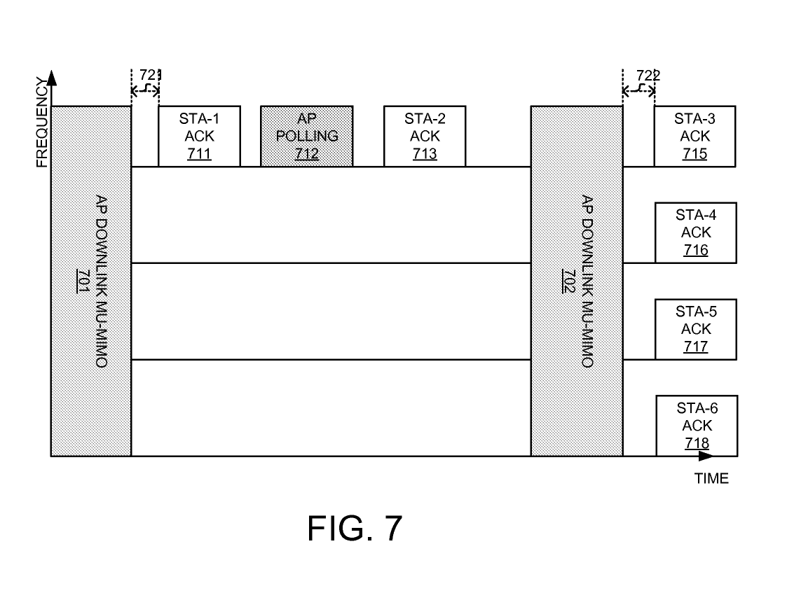

FIG. 7 shows an exemplary diagram of a mixed use the sequential responding frames and the concurrent OFDMA uplink responding frames in accordance with embodiments of the current invention. At step 701, the wireless communication station sends downlink wideband signal to multiple wireless communications devices, STA-1 and STA-2. STA-1 and STA-2 is setup to send responding frames sequentially. After SIFS 721, STA-1 sends the responding frame step 711. At step 712, AP polls the other wireless communications devices for responses. At step 713, STA-2 sends the responding frames in response to the AP polling. At step 702 the wireless communication station sends downlink wideband signal to multiple wireless communications devices, STA-3, STA-4, STA-5, and STA-6. STA-3, STA-4, STA-5, and STA-6 are configured to send their responding frames concurrently using uplink OFDMA. After SIFS 722, STA3, STA-4, STA-5, and STA-6 sends their corresponding responding frames at steps 714, 715, 716, 717 and 718, respectively.

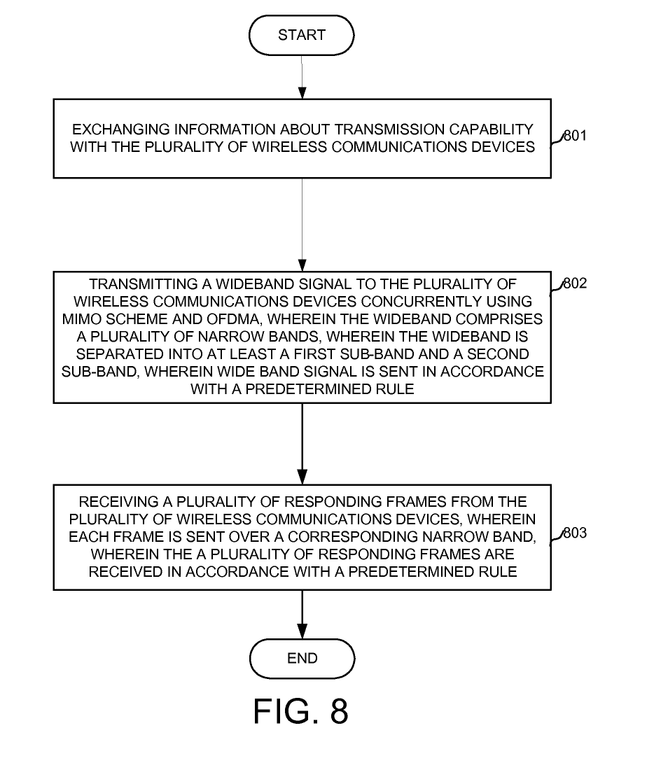

FIG. 8 shows an exemplary flow chart of a wireless station performs downlink MIMO/OFDMA with uplink MU responding frames using OFDMA in accordance with embodiments of the current invention. At step 801, the wireless station exchanges information about transmission capability with the plurality of wireless communications devices. At step 802, the wireless station transmits a wideband signal to the plurality of wireless communications devices concurrently using MIMO scheme and OFDMA, wherein the wideband comprises a plurality of narrow bands, wherein the wideband is separated into at least a first sub-band and a second sub-band, wherein wide band signal is sent in accordance with a predetermined rule. At step 803, the wireless station receives a plurality of responding frames from the plurality of wireless communications devices, wherein each frame is sent over a corresponding narrow band, wherein the a plurality of responding frames are received in accordance with a predetermined rule.

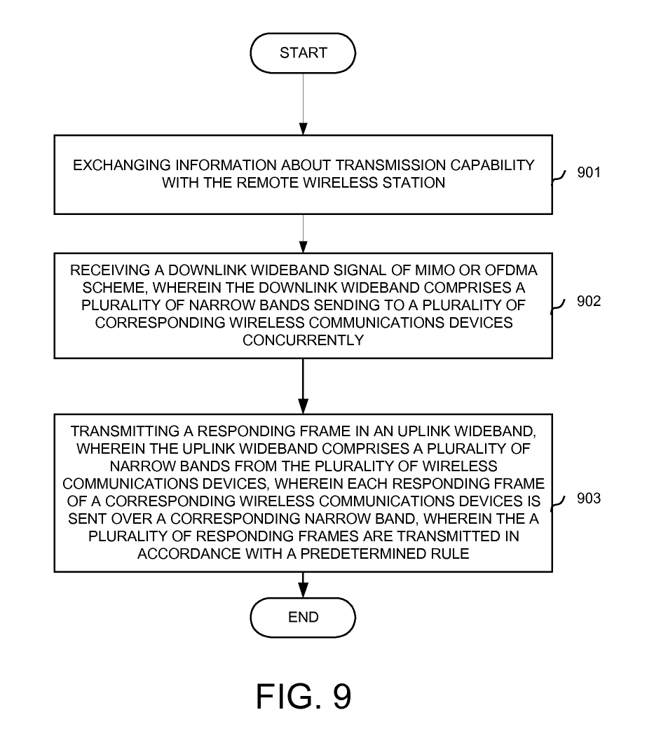

FIG. 9 shows an exemplary flow chart of a wireless communication device performs downlink MIMO/OFDMA with uplink MU responding frames using OFDMA in accordance with embodiments of the current invention. The wireless communications device exchanges information regarding transmission capability with a remote wireless station at step 901. At step 902, the wireless communications device receives a downlink wideband signal of MIMO or OFDMA scheme, wherein the downlink wideband comprises a plurality of narrow bands sending to a plurality of corresponding wireless communications devices concurrently. At step 903, the wireless communications device transmits a responding frame in an uplink wideband, wherein the uplink wideband comprises a plurality of narrow bands from the plurality of wireless communications devices, wherein each responding frame of a corresponding wireless communications devices is sent over a corresponding narrow band, wherein the a plurality of responding frames are transmitted in accordance with a predetermined rule.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method for communicating with a plurality of wireless communications devices by using multiple users multiple input and multiple output (MU-MIMO) and Orthogonal Frequency Demodulation Multiple Access (OFDMA)transmission, comprising:
exchanging information about transmission capability with the plurality of wireless communications devices;
transmitting a wideband signal to the plurality of wireless communications devices concurrently using MIMO scheme and OFDMA, wherein the wideband comprises a plurality of narrow bands, wherein the wideband is separated into at least a first sub-band and a second sub-band, wherein the wide band signal is sent in accordance with a predetermined rule; and
receiving a plurality of responding frames from the plurality of wireless communications devices, wherein each frame is sent over a corresponding narrow band, wherein the a plurality of responding frames are received in accordance with a predetermined rule.

2. The method of claim 1, wherein a wide band signal sent in the first sub-band comprises a plurality of frames in MIMO format and is sent to the first set of corresponding wireless communication devices, wherein the signals sent in the second sub-band comprises a plurality of frames in OFDMA format and is sent to the second set of corresponding wireless communication devices.

3. The method of claim 1, wherein the predetermined rule is a responding frame from each of the plurality of wireless communications devices is sent on a corresponding narrow band and the plurality of frames are sent concurrently.

4. The method of claim 3, wherein the plurality of frames are sent concurrently using OFDMA.

5. The method of claim 3, further comprising: transmitting a multi-user (MU) indication bit that indicates concurrent responding frames from multiple wireless communications devices.

6. The method of claim 5, wherein the MU indication bit is in physical layer signal (PHY SIG) field.

7. The method of claim 3, further comprising: transmitting MU bandwidth assignment information in the MIMO wideband signal.

8. The method of claim 7, wherein the MU bandwidth assignment is in PHY SIG field.

9. The method of claim 3, wherein the concurrent responding frames occupies less than a bandwidth of an available wideband channel, further comprising: leaving unoccupied bandwidth with no energy.

10. The method of claim 3, wherein the concurrent responding frames occupies less than a bandwidth of an available wideband channel, further comprising: occupying unoccupied bandwidth with one or more duplicated responding frames selected from at least one of the responding frames of the wireless communications devices.

11. The method of claim 1, wherein the predetermined rule is a responding frame from each of the plurality of wireless communications devices is sent on a corresponding narrow band and the plurality of the corresponding frames are sent concurrently over more than one transmission instance.

12. The method of claim 11, further comprising: polling a second set of wireless communications devices for responding frames for a second transmission instance after transmitting a first set of responding frames.

13. The method of claim 1, wherein the predetermined rule is a responding frame from each of the plurality of wireless communications devices is sent on one or more narrow bands and the plurality of frames are sent sequentially.

14. A method for responding to multiple users multiple input and multiple output (MU-MIMO) or orthogonal frequency division multiple access (OFDMA) transmission from a remote wireless station by a wireless communications device, comprising:
exchanging information about transmission capability with the remote wireless station;
receiving a downlink wideband signal of MIMO or OFDMA scheme, wherein the downlink wideband comprises a plurality of narrow bands sending to a plurality of corresponding wireless communications devices concurrently; and
transmitting a responding frame in an uplink wideband, wherein the uplink wideband comprises a plurality of narrow bands from the plurality of wireless communications devices, wherein each responding frame of a corresponding wireless communications devices is sent over a corresponding narrow band, wherein the a plurality of responding frames are transmitted in accordance with a predetermined rule.

15. The method of claim 14, wherein the predetermined rule is a responding frame from each of the plurality of wireless communications devices is sent on a corresponding narrow band and the plurality of frames are sent concurrently using the uplink wideband.

16. The method of claim 15, wherein the plurality of frames are sent concurrently using OFDMA.

17. The method of claim 14, further comprising: receiving a multi-user (MU) indication bit that indicates concurrent responding frames from multiple wireless communications devices.

18. The method of claim 17, wherein the MU indication bit is in physical layer signal (PHY SIG) field.

19. The method of claim 15, further comprising: receiving MU bandwidth assignment information in the MIMO wideband signal.

20. The method of claim 19, wherein the MU bandwidth assignment is in PHY SIG field.

21. The method of claim 15, wherein the concurrent responding frames occupies less than a bandwidth of an available wideband channel, further comprising: leaving unoccupied bandwidth with no energy.

22. The method of claim 15, wherein the concurrent responding frames occupies less than a bandwidth of an available wideband channel, further comprising: occupying unoccupied bandwidth with one or more duplicated responding frames selected from at least one of the responding frames of the wireless communications devices.

23. The method of claim 14, wherein the predetermined rule is a responding frame from each of the plurality of wireless communications devices is sent on a corresponding narrow band and the plurality of the corresponding frames are sent concurrently over more than one transmission instance.

24. The method of claim 23, further comprising: receiving a polling for the responding frame for a second transmission instance.

25. The method of claim 24, wherein the predetermined rule is a responding frame from each of the plurality of wireless communications devices is sent on one or more narrow bands and the plurality of frames are sent sequentially.
